(19) United States
(12) Patent Application Publication
(10) Pub. No.: US 2013/0085753 A1
(43) Pub. Date: Apr. 4, 2013

(54) Hybrid Client/Server Speech Recognition In A Mobile Device

(71) Applicants: Bjorn Erik Bringert, Bath (GB); Johan Schalkwyk, Scarsdale, NY (US); Michael J. LeBeau, New York, NY (US); Richard Zarek Cohen, London (GB); Luca Zanolin, London (GB); Simon Tickner, Whitstable (GB)

(72) Inventors: Bjorn Erik Bringert, Bath (GB); Johan Schalkwyk, Scarsdale, NY (US); Michael J. LeBeau, New York, NY (US); Richard Zarek Cohen, London (GB); Luca Zanolin, London (GB); Simon Tickner, Whitstable (GB)

(73) Assignee: GOOGLE INC., Mountain View, CA (US)

(21) Appl. No.: 13/586,696

(22) Filed: Aug. 15, 2012

Related U.S. Application Data
(60) Provisional application No. 61/542,052, filed on Sep. 30, 2011.

(51) Int. Cl. G10L 15/20

(52) U.S. Cl. 704/233; 704/E15.039

(57) ABSTRACT

A computing device is able to use an embedded speech recognizer and a network speech recognizer for speech recognition. In response to detecting speech in the captured audio, the computing device may forward the captured audio to its embedded speech recognizer and to a speech client for the network speech recognizer. The embedded speech recognizer provides an embedded-recognizer result for the captured audio. If a network-recognition criterion is met, the speech client forwards the captured audio to the network speech recognizer and receives a network-recognizer result for the captured audio from the network speech recognizer. A speech recognition result for the captured audio is forwarded to at least one application, wherein the speech recognition result is based on at least one of the embedded-recognizer result and the network-recognizer result.

### CROSS-REFERENCE TO RELATED APPLICATIONS

This patent application claims priority to U.S. Provisional Application No. 61/542,052, filed on Sep. 30, 2011, the contents of which are entirely incorporated herein by reference, as if fully set forth in this application.

### BACKGROUND

Unless otherwise indicated herein, the materials described in this section are not prior art to the claims in this application and are not admitted to be prior art by inclusion in this section.

Computing devices, such as mobile devices, are increasingly using speech recognition in order to receive and act in response to spoken input from a user. In one approach for speech recognition, a mobile device runs a speech recognizer that is provisioned into the device (an embedded speech recognizer). In another approach for speech recognition, a mobile device communicates with a server (a network speech recognizer) through a communication network. The network speech recognizer performs speech recognition remotely and returns a speech recognition result to the mobile device through the communication network.

### SUMMARY

In a first aspect, a method for a computing device is provided. The computing device includes at least one application, a speech detector, an embedded speech recognizer, and a speech client for a network speech recognizer. In the method, audio is captured at the computing device. The speech detector detects speech in the captured audio. In response to detecting speech in the captured audio, the captured audio is forwarded to the embedded speech recognizer and to the speech client. An embedded-recognizer result for the captured audio is received from the embedded speech recognizer. In response to a determination that a network-recognition criterion is met, the speech client forwards the captured audio to the network speech recognizer. A network-recognizer result for the captured audio is received from the network speech recognizer. A speech-recognition result for the captured audio is forwarded to the at least one application. The speech-recognition result is based on at least one of the embedded-recognizer result and the network-recognizer result.

In a second aspect, a computer readable medium having stored instructions is provided. The instructions are executable by at least one processor to cause a computing device to perform functions. The functions include: capturing audio; detecting speech in the captured audio; in response to detecting speech in the captured audio, forwarding the captured audio to an embedded speech recognizer and a speech client; receiving an embedded-recognizer result for the captured audio from the embedded speech recognizer; determining whether a network-recognition criteria is met; in response to determining that a network-recognition criterion is met, forwarding the captured audio from the speech client to a network speech recognizer; receiving a network-recognizer result for the captured audio from the network speech recognizer; and forwarding a speech-recognition result for the captured audio to at least one application. The speech-recognition result is based on at least one of the embedded-recognizer result and the network-recognizer result.

In a third aspect, a computing device is provided. The computing device includes: an audio system for capturing audio; a speech detector for detecting speech in the captured audio; an embedded speech recognizer configured to generate an embedded-recognizer result for the captured audio; a speech client configured to forward the captured audio to a network speech recognizer and to receive a network-recognizer result from the network speech recognizer; and a speech input controller configured to determine whether to forward the embedded-recognizer result or the network-recognizer result to at least one application.

### BRIEF DESCRIPTION OF THE DRAWINGS

FIG. 1 is block diagram of a computing device, in accordance with an example embodiment.

FIG. 2 is a flow chart of a method, in accordance with an example embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description and figures are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### 1. OVERVIEW

Network speech recognizers tend to be more accurate than embedded speech recognizers. This is because a network speech recognizer can be run on one or more servers that have more processing power, storage space, and memory than a typical computing device that runs an embedded speech recognizer However, a network speech recognizer relies on a network connection to return a speech recognition result to a computing device. Thus, how quickly a computing receives a speech recognition result from a network speech recognizer may depend on the quality of the network connection. Moreover, if a network connection is unavailable, then a computing device may be unable to use a network speech recognizer for speech recognition. Embedded speech recognizers tend to be faster and more reliable than network speech recognizers because they do not rely on a network connection. However, embedded speech recognizers tend to be less accurate than network speech recognizers.

In order to balance the advantages and disadvantages of embedded speech recognizers and network speech recognizers, a computing device may include an embedded speech recognizer and also include a speech client for communicating with a network speech recognizer through a communication network. Further, the computing device may include a speech input controller (e.g., in the form of a stored program) for controlling the embedded speech recognizer and the speech client. For example, the speech input controller may determine when to invoke the embedded speech recognizer and when to invoke the network speech recognizer through the speech client. The speech input controller may also determine whether to use a recognition result from the embedded speech recognizer or a speech recognition result from the network speech recognizer, for example, as input to an application running on the computing device. The speech input controller may make this determination based on timeliness (e.g., whether the embedded speech recognizer or the network speech recognizer returns a speech recognition result fist) and/or based on the confidence of the speech recognition results.

In one example, an audio recorder in the computing device is activated and captures audio that is received through an audio system (e.g., an internal or external microphone). The captured audio is then passed to a local endpointer (speech detector). When the speech detector detects speech in the captured audio, the captured audio may be forwarded to both the embedded speech recognizer and to the speech client for transmission to the network speech recognizer through the communication network. To arbitrate between the embedded speech recognizer and the network speech recognizer, the speech input controller may use any combination of the following methods:
If a network connection is not available or is not available with a sufficient quality, use the embedded speech recognizer without invoking the network speech recognizer;
Invoke both the embedded speech recognizer and the network speech recognizer, but if the network speech recognizer does not provide a speech recognition result within a predetermined timeout period, use only the speech recognition result from the embedded speech recognizer;
Invoke both the embedded speech recognizer and the network speech recognizer, but if the embedded speech recognizer returns a speech recognition result first, use the result from the embedded speech recognizer as a basis for generating visual feedback to display to the user;
Invoke both the embedded speech recognizer and the network speech recognizer, but if the embedded speech recognizer recognizes an action phrase (such as a voice command), update the user interface based on the action phrase even before the network speech recognizer returns a speech recognition result (and potentially even before the user has completed his or her voice input); and
Invoke both the embedded speech recognizer and the network speech recognizer, but if the embedded speech recognizer returns a speech recognition result with a confidence that is over a predetermined threshold confidence, the result from the embedded speech recognizer can be used without waiting to receive a result from the network speech recognizer.

In this way, a speech recognition result for captured audio that is returned from an embedded speech recognizer can beneficially be used without waiting for the network speech recognizer's speech recognition result for the captured audio, at least when the result from the embedded speech recognizer has a sufficiently high confidence.

### 2. EXAMPLE COMPUTING DEVICE

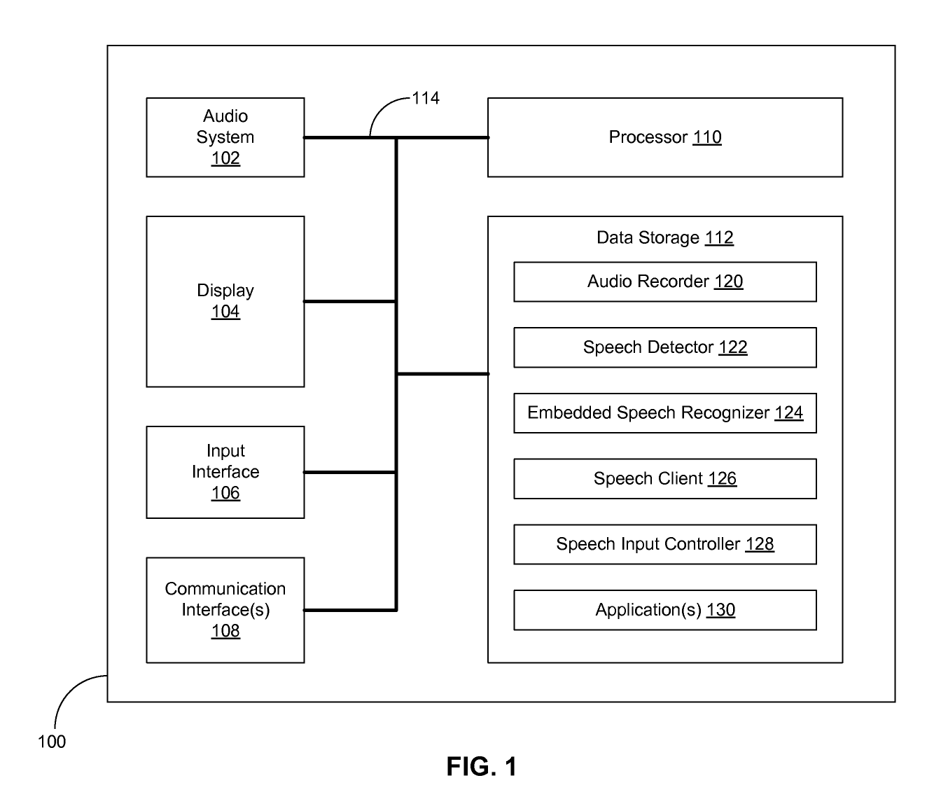

FIG. 1 is a block diagram of an example computing device 100. Computing device 100 could be a mobile device, such as a laptop computer, tablet computer, handheld computer, or smartphone. Alternatively, computing device 100 could be a fixed-location device, such as a desktop computer. In this example, computing device 100 is a speech-enabled device. Thus, computing device 100 may include an audio system 102 that is configured to receive audio from a user (e.g., through a microphone) and to convey audio to the user (e.g., through a speaker). The received audio could include speech input from the user. The conveyed audio could include speech prompts to the user.

Computing device 100 may also include a display 104 for displaying visual information to the user. The visual information could include, for example, text, speech, graphics, and/or video. Display 104 may be associated with an input interface 106 for receiving physical input from the user. For example, input interface 106 may include a touch-sensitive surface, a keypad, or other controls that the user may manipulate by touch (e.g., using a finger or stylus) to provide input to computing device 100. In one example, input interface 106 includes a touch-sensitive surface that overlays display 104.

Computing device 100 may also include one or more communication interface(s) 108 for communicating with external devices, such as a network speech recognizer. Communication interface(s) 108 may include one or more wireless interfaces for communicating with external devices through one or more wireless networks. Such wireless networks may include, for example, 3G wireless networks (e.g., using CDMA, EVDO, or GSM), 4G wireless networks (e.g., using WiMAX or LTE), or wireless local area networks (e.g., using WiFi). In other examples, communication interface(s) 108 may access a communication network using Bluetooth®, Zibee®, infrared, or other form of short-range wireless communication. Instead of or in addition to wireless communication, communication interface(s) 108 may be able to access a communication network using one or more wireline interfaces (e.g., Ethernet). The network communications supported by communication interface(s) 108 could include, for example, packet-based communications through the Internet or other packet-switched network.

The functioning of computing device 100 may be controlled by one or more processors, exemplified in FIG. 1 by processor 110. More particularly, the one or more processors may execute instructions stored in a non-transitory computer readable medium to cause computing device 100 to perform functions. In this regard, FIG. 1 shows processor 110 coupled to data storage 112 through a bus 114. Processor 110 may also be coupled to audio system 102, display 104, input interface 106, and communication interface(s) 108 through bus 114.

Data storage 112 may include, for example, random access memory (RAM), read-only memory (ROM), flash memory, cache memory, or other non-transitory computer readable media. Data storage 112 may store data as well as instructions that are executable by processor 110.

In one example, the instructions stored in data storage 112 include instructions that, when executed by processor 110, provide the functions of an audio recorder 120, a speech detector 122, an embedded speech recognizer 124, a speech client 126, a speech input controller 128, and one or more applications(s) 130. The audio recorder 120 may be configured to capture audio received by audio system 102. The speech detector 122 may be configured to detect speech in the captured audio. The embedded speech recognizer 124 may be configured to return a speech recognition result (which may include, for example, text and/or recognized voice commands) in response to receiving audio input. The speech client 126 is configured to communicate with a network speech recognizer, including forwarding audio to the network speech recognizer and receiving from the network speech recognizer a speech recognition result for the audio. The speech input controller 128 may be configured to control the use of the embedded and network speech recognizers. Application(s) 130 may include one or more applications for e-mail, text messaging, social networking, telephone communications, games, playing music, etc.

Although FIG. 1 shows audio recorder 120, speech detector 122, embedded speech recognizer 124, speech client 126, speech input controller 128, and applications(s) 130 as being implemented through software, some or all of these functions could be implemented as hardware and/or firmware. It is also to be understood that the division of functions among modules 120-130 shown in FIG. 1 and described above is only one example; the functions of modules 120-130 could be combined or divided in other ways.

### 3. EXAMPLE METHODS

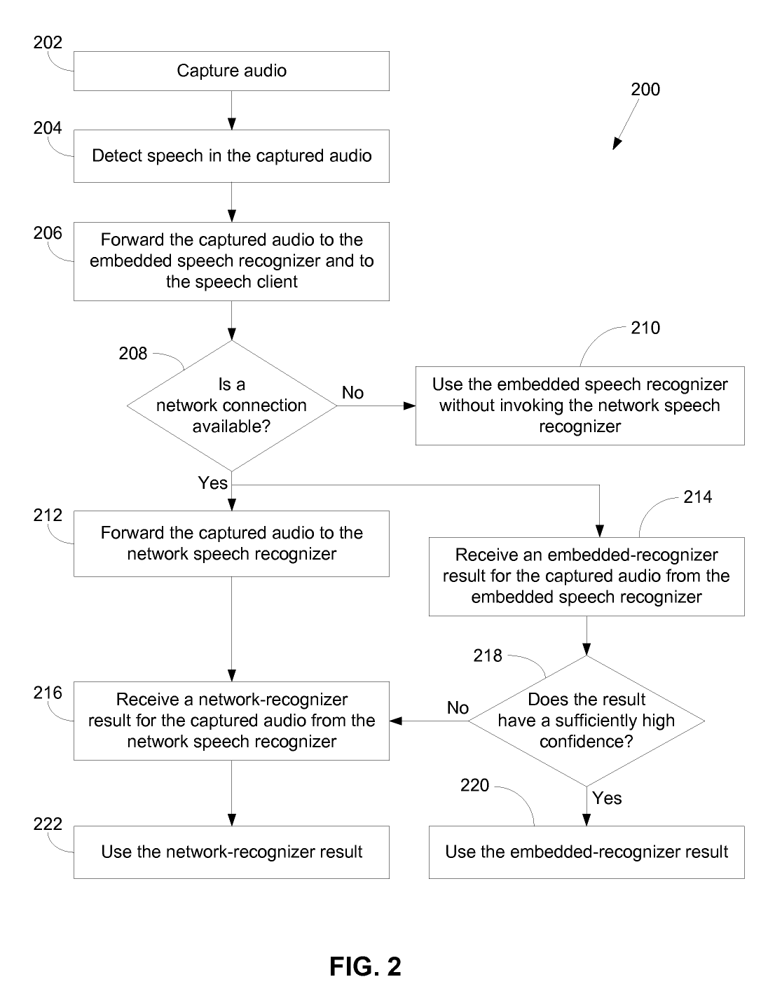

FIG. 2 is a flow chart illustrating an example method 200. For purposes of illustration, method 200 is explained with reference to the computing device 100 shown in FIG. 1. It is to be understood, however, that other types of computing devices could be used.

When method 200 is activated, audio is captured at the computing device (e.g., using audio recorder 120), as indicated by block 202. Method 200 could be activated automatically, for example, in response to the audio level reaching a certain threshold volume. Alternatively, method 200 could be activated in response to a predetermined user input, for example, a user instruction received through input interface 106.

At some point, speech is detected in the captured audio, as indicated by block 204. The speech detection could be performed by speech detector 122. In response to detecting speech in the captured audio, the captured audio is forwarded to an embedded speech recognizer and to a speech client for possible transmission to a network speech recognizer, as indicated by block 206. Whether the speech client forwards the captured audio to the network speech recognizer may depend on whether a network connection is available with sufficient quality or available at all, as indicated by block 208. If a network connection is not available, then the embedded speech recognizer may be used to obtain a speech result from the captured audio, without invoking the network speech recognizer, as indicated by block 210.

If a network connection is available, then the speech client forwards the captured audio to the network speech recognizer, as indicated by block 212. In this way, the embedded speech recognizer and the network speech recognizer may process the captured audio in parallel. Eventually, the computing device receives an embedded-recognizer result for the captured audio from the embedded speech recognizer (as indicated by block 214) and receives a network-recognizer result from the network speech recognizer (as indicated by block 216).

In this example, it is assumed that the embedded-recognizer result is received first. Thus, even before the computing device receives the network-recognizer result from the network speech recognizer, the computer device may receive and evaluate the embedded-recognizer result from the embedded speech recognizer. This evaluation may include a determination of whether the embedded-recognizer result has a sufficiently high quality, as indicated by block 218. For example, speech input controller 128 may compare the confidence of the embedded-recognizer result with a predetermined threshold confidence. If the confidence is greater than (or equal to) the threshold confidence, then the embedded-recognizer result may be used as the speech-recognition result for the captured audio, as indicated by block 220. For example, speech input controller 128 may forward the embedded-recognizer result to one or more of application(s) 130 as input.

On the other hand, if the embedded-recognition result does not have a sufficiently high confidence (e.g., lower than then threshold confidence), then the computing device may wait to receive the network-recognizer result from the network speech recognizer (block 216) and use the network-recognizer result as the speech-recognition result for the captured audio, as indicated by block 222. For example, speech input controller 128 may forward the network-recognizer result to one or more of application(s) 130 as input.

In this way, the speech input controller may forward to one or more applications a speech-recognition result for the captured audio that is based on at least one of the embedded-recognizer result and the network-recognizer result, for example, depending on which result is more timely and/or has a higher confidence. For example, the speech input controller may provide the embedded-recognizer result, the network-recognizer result, or a combination thereof as the speech-recognition result used by the one or more applications.

The speech input controller could also control whether the network speech recognizer is invoked at all, for example, by determining whether a network-recognition criterion is met. The determination could involve determining whether the network speech recognizer is available through the communication network (as indicated by block 208). Alternatively, the determination could be based on whether the embedded-recognizer result has a sufficiently high confidence. For example, the captured audio might be forwarded to the network speech recognizer only after the embedded speech recognizer fails to produce a high confidence result.

Multiple speech-recognition results may be obtained from a user's voice input. For example, one or more of the speech-recognition results may be used to select a specific application, and subsequent speech-recognition results may be used as input to that the application. This type of scenario is illustrated by the following example:
1. The user of a computing device begins speaking and includes an action phrase, “messages,” in the user's utterance.
2. The embedded speech recognizer in the computing device recognizes the action phrase “messages” with a high confidence. In this case, the action phrase, “messages,” identifies a messaging application.
3. The computing device updates a graphical user interface (GUI) to show the actions available in the messaging application.
4. The user continues speaking (without interruption): “ . . . new message . . . ” In this case, “new message” is one of the actions that the GUI indicates is available in the messaging application.
5. The embedded speech recognizer recognizes the action phrase “new message” with a high confidence.
6. The computing device updates the GUI to show the slots available for the “new message” action.
7. The user continues speaking: “ . . . to Bob . . . ”
8. The embedded speech recognizer recognizes (using a limited grammar or language model) the slot name “to” and the contact name “Bob” with high confidence.
9. The messaging application populates the “to” slot in the “new message” action based on the contact name “Bob.”
10. The user continues speaking: “ . . . hi Bob, I've got to run some errands. Do you want to meet in the pub at eight thirty?”
11. The embedded speech recognizer does not return a high confidence result. This may occur, for example, because one or more elements of this utterance are not supported in the limited grammars or language models used by the embedded speech recognizer.
12. However, the user's speech is also being sent to the network speech recognizer. The network speech recognizer streams back the dictation results.
13. The streaming results are displayed in the message slot as they come in.
14. After the user has finished speaking, any final results from the network recognizer are displayed in the message slot.
15. The messaging application sends the message dictated by the user after receiving final confirmation from the user.

In this way, results from the embedded speech recognizer (which may be received before the results from the network speech recognizer) can be used to bring up a specific application and to invoke an action supported by the application. However, when the embedded speech recognizer is unable to return a high confidence result, the results from the network speech recognizer can be used instead. This can be particularly useful when the user is dictating a message that is not limited to specific action phrases or keywords, such as may be supported by simple grammars or language models used by the embedded speech recognizer.

It is to be understood that the computing device may stream the captured audio to just one of the recognizers or to both of the recognizers once the speech detector has detected speech in the captured audio. Further, the network speech recognizer does not necessarily stream its speech recognition results back to the computing device. Alternatively, the network speech recognizer could return its result in a single response.

### 4. NON-TRANSITORY COMPUTER READABLE MEDIUM

Some or all of the functions described above and illustrated in FIG. 2 may be performed by a computing device (such as computing device 100 shown in FIG. 1) in response to the execution of instructions stored in a non-transitory computer readable medium. The non-transitory computer readable medium could be, for example, a random access memory (RAM), a read-only memory (ROM), a flash memory, a cache memory, one or more magnetically encoded discs, one or more optically encoded discs, or any other form of non-transitory data storage. The non-transitory computer readable medium could also be distributed among multiple data storage elements, which could be remotely located from each other.

### 5. CONCLUSION

The above detailed description describes various features and functions of the disclosed systems, devices, and methods with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for a computing device, the computing device including at least one application, a speech detector, an embedded speech recognizer, and a speech client for a network speech recognizer, the method comprising:
capturing audio at the computing device;
the speech detector detecting speech in the captured audio;
in response to detecting speech in the captured audio, forwarding the captured audio to the embedded speech recognizer and to the speech client;
receiving an embedded-recognizer result for the captured audio from the embedded speech recognizer;
determining whether a network-recognition criterion is met;
in response to a determination that a network-recognition criterion is met, the speech client forwarding the captured audio to the network speech recognizer;
receiving a network-recognizer result for the captured audio from the network speech recognizer; and
forwarding a speech-recognition result for the captured audio to the at least one application, wherein the speech-recognition result is based on at least one of the embedded-recognizer result and the network-recognizer result.

2. The method of claim 1, wherein determining whether a network-recognition criterion is met comprises determining whether the network speech recognizer is available through a communication network.

3. The method of claim 1, wherein determining whether a network-recognition criterion is met comprises determining whether the embedded-recognizer result has a sufficiently high confidence.

4. The method of claim 1, further comprising:
comparing a confidence of the embedded-recognizer result with a threshold confidence;
if the confidence is greater than the threshold confidence, using the embedded-recognizer result as the speech-recognition result; and
if the confidence is less than the threshold confidence, using the network-recognizer result as the speech-recognition result.

5. The method of claim 1, wherein the computing device displays a graphical user interface (GUI), further comprising:
receiving the embedded-recognizer result before receiving the network-recognizer result; and
responsively displaying content in the GUI, wherein the content is based on the embedded-recognizer result.

6. The method of claim 5, wherein the content comprises text that corresponds to the embedded-recognizer result.

7. The method of claim 5, wherein the embedded-recognizer result comprises an action phrase.

8. The method of claim 7, further comprising:
updating the GUI based on the an action phrase.

9. The method of claim 8, wherein the action phrase identifies the at least one application.

10. A computer readable medium having stored therein instructions executable by at least one processor to cause a computing device to perform functions, the functions comprising:
capturing audio;
detecting speech in the captured audio;
in response to detecting speech in the captured audio, forwarding the captured audio to an embedded speech recognizer and a speech client;
receiving an embedded-recognizer result for the captured audio from the embedded speech recognizer;
determining whether a network-recognition criterion is met;
in response to determining that a network-recognition criterion is met, forwarding the captured audio from the speech client to a network speech recognizer;
receiving a network-recognizer result for the captured audio from the network speech recognizer; and
forwarding a speech-recognition result for the captured audio to at least one application, wherein the speech-recognition result is based on at least one of the embedded-recognizer result and the network-recognizer result.

11. A computing device, comprising:
an audio system for capturing audio;
a speech detector for detecting speech in the captured audio;
an embedded speech recognizer configured to generate an embedded-recognizer result for the captured audio;
a speech client configured to forward the captured audio to a network speech recognizer and to receive a network-recognizer result from the network speech recognizer; and
a speech input controller configured to determine whether to forward the embedded-recognizer result or the network-recognizer result to at least one application.

12. The computing device of claim 11, further comprising a communication interface.

13. The computing device of claim 12, wherein the speech client is configured to forward the captured audio to the network speech recognizer and to receive the network-recognizer result from the network speech recognizer via the communication interface.

14. The computing device of claim 11, wherein the speech input controller is configured to compare a confidence of the embedded-recognizer result with a predetermined threshold confidence.

15. The computing device of claim 14, wherein the speech input controller is configured to forward the embedded-recognizer result to the at least one application if the confidence of the embedded-recognizer result is greater than the predetermined threshold confidence.

16. The computing device of claim 14, wherein the speech input controller is configured to forward the network-recognizer result to the at least one application if the confidence of the embedded-recognizer result is less than the predetermined threshold confidence.

17. The computing device of claim 11, wherein the speech input controller is configured to identify the at least one application based on the embedded-recognizer result.

18. The computing device of claim 17, further comprising a display that is configured to display a graphical user interface (GUI) that indicates available actions in the at least one application.

19. The computing device of claim 18, wherein the at least one application is configured to select one of the available actions based on the embedded-recognizer result.

20. The computing device of claim 19, wherein the speech input controller is configured to determine whether to forward the embedded-recognizer result or the network-recognizer result to the at least one application as input for the selected action based on a confidence of the embedded-recognizer result.
